(19) United States
(12) Patent Application Publication
(10) Pub. No.: US 2004/0202597 A1
(43) Pub. Date: Oct. 14, 2004

(54) Gas purification

(76) Inventors: Rolf Hesbol, Nykoping (SE); Karl-Axel Barkentin, Hoganas (SE); Fredrik Eklund, Goteborg (SE)

Correspondence Address: BURNS DOANE SWECKER & MATHIS L L P, POST OFFICE BOX 1404, ALEXANDRIA, VA, 22313-1404, US

(21) Appl. No.: 10/732,228

(22) Filed: Dec. 11, 2003

(30) Foreign Application Priority Data
Apr. 11, 2003 (SE) 0301071-7

(51) Int. Cl. B01D 53/50

(52) U.S. Cl. 423/244.06

(57) ABSTRACT

The invention concerns a new method for desulfurization of syngas. The method comprises contacting a sulphur containing syngas having a temperature between 300° C. and 800° C. gas with a sorbent containing metallic iron in order to form a sulphur containing iron compound and a gas substantially free from sulphur or sulphur containing compounds.

### FIELD OF THE INVENTION

The present invention relates to a method for desulfurization of gases. More particularly the invention concerns a method of desulfurization of syngas obtained form pyrolysis or gasification of organic material.

### BACKGROUND OF THE INVENTION

There is a growing interest in pyrolysis and gasification as a means of processing waste as well as making large scale energy production more economical and environmentally acceptable. An attractive alternative to direct combustion of the syngas generated at the pyrolysis or gasification is to produce liquid fuels or chemicals from it. The utilization of the hydrogen fraction of the syngas in fuel cells is also of great interest for the future.

The syngas consists to a large extent of a mixture of carbon monoxide (CO) and hydrogen (H₂). Depending on the sulphur contents of the raw material subjected to the pyrolysis/gasification, the syngas will also contain a significant amount of hydrogen sulfide (H₂S), as well as smaller amounts of other sulfur compounds (carbonyl sulfide (COS), carbon disulfide (CS₂), mercaptans and thiophenic compounds etc).

The presence of these sulphur-containing gases in the syngas give rise to problems when the syngas is used for the purposes mentioned above. Thus, when sulphur containing syngas is used as fuels the combustion of such fuel will be strictly regulated in most countries for environmental reasons. Combustion of the sulphur-containing gases results in the formation of SOₓ which goes up into the atmosphere and generates acid rains, which in turn leads to corrosion on man-made objects and acidification of soil and water. Another problem is that sulphur has a negative impact on catalysts for NOₓ emission control, and that hydrogen sulphide causes corrosion on process equipment.

When the syngas is to be used for energy production, either by direct combustion in a power plant, or for production of liquid fuels or chemicals, it is thus desirable to remove most of the sulphur, thereby reducing the emissions of acid SO₂ and into the atmosphere.

Known technologies for removal of sulphur from reducing gases include wet methods, such as amine scrubbing, as well as the use of dry sorbents.

Wet scrubbing has the disadvantage of requiring the gas to be cooled down to relatively low temperatures prior to the scrubbing operation. This requires much energy. In some cases wet scrubbing also has the disadvantage of being unselective, removing all acid components of the gas, including CO₂.

Much effort has been made over the years to develop dry sorbents for use in hot gas streams, thus removing the need for cooling the gas. A large number of dry sorbents for removal of sulphur, in particular hydrogen sulphide, from hot reducing gases have been described. These sorbents generally consist of transition metal oxides, often in the form of a mixture of several different metal oxides. The metal oxide is most often mixed with a binder and/or support material, shaped into particles, and subsequently calcinated at elevated temperatures.

There are several patents on dry sorbents, among which can be mentioned: U.S. Pat. No. 4,225,417 concerning an Mn-oxide based sorbent for removal of sulphur compounds from hydrocarbon gas streams, U.S. Pat. No. 5,753,198 concerning Zn-titanate based sorbents for removal of sulphur compounds from gasified coal, U.S. Pat. No. 4,251,495 concerning use of metallic Cu for removal of H₂S from non-oxidising gases. The U.S. Pat. Nos. 5,703,003 and 5,494,880 concern Zn-oxide based sorbents for removal of sulphur from gasified coal. Other patents in this field are the U.S. Pat. No. 5,045,522 (Zn-titanate for removal of H₂S from fluid streams), the U.S. Pat. No. 5,306,685 (Fe,Zn,Ni-oxide sorbent for removal of H₂S from gases)., the US patent application 2001/0029311 A1 (removal of sulphur compounds from cracked gasoline or diesel fuels in gas phase).

The use of iron in connection with gas purification is mentioned in the U.S. Pat. No. 5,536,896, which discloses a pyrolysis process which includes a purification step where sulphur is removed from the pyrolysis gas by contacting said gas with a bed of sulphide-forming metal. Additionally the U.S. Pat. No. 4,608,240 discloses a method for desulfurization of natural gas by heating it to 250° C.-450° C. and contacting the gas with a bed of sponge iron. Finally, the U.S. Pat. No. 4,857,284 discloses a process for removing sulphur from the waste gas from a reduction shaft furnace by employing sponge iron as a sorbent at low temperature. Surprisingly, it is claimed that low temperature is advantageous.

### OBJECTS OF THE INVENTION

An object of the present invention is to provide a dry method for desulfurization.

Another object is to provide a method which requires no or only limited cooling of the syngas generated by pyrolysis or gasification of the organic material before desulphurization.

A further object is to provide a process which is environmentally advantageous and does not leave hazardous residues.

Other objects, features and advantages of the invention are evident from the description below.

### SUMMARY OF THE INVENTION

In brief the present invention concerns a method for desulfurization of syngas comprising contacting a sulphur containing syngas having a temperature between 300° C. and 800° C. gas with a sorbent containing metallic iron in order to form a sulphur-containing iron compound and a gas substantially free from sulphur or sulphur-containing compounds.

### DETAILED DESCRIPTION OF THE INVENTION

The syngas may be obtained by gasification or pyrolysis of solid or liquid organic material such as coal, petroleum, bio-fuels, or waste such as plastic, rubber, mixed household waste. Other methods of obtaining syngas are by reformation of petroleum, natural gas and other gases.

The combustible components of the syngas used according to the present invention normally includes at least 50% by volume of carbon monoxide and hydrogen. Additionally, the most promising results have been obtained when the syngas is essentially non-oxidizing for iron.

The sorbent could have any shape and composition but should include metallic iron as active component for binding sulphur or sulphur-containing compounds. Thus the sorbent may for example be in the form of steel wool, although it is preferred to use particles as these will better keep their structure when transformed to iron sulphide. In addition to the metallic iron the sorbent may include a carrier which is inert during the process conditions and which acts as support for the iron. The sorbent can of course also include substances which have the ability to decrease the amounts of harmful components other than sulphur from the syngas.

Preferably the metallic iron is in the form of particles the size of which may vary between 0.01 and 10 mm, preferably between 0.1 and 5 mm. According to an especially preferred embodiment the metallic iron is present in the form of sponge iron particles having a surface area (as measured according to the B.E.T. method) of at least 25 m²/kg. Preferably the surface area is in the range 75-2000 m²/kg. The metallic iron content of the sorbent should preferably be more than 50, preferably more than 90% by weight.

Sponge iron is a porous material produced by solid state reduction of iron oxide (such as iron ore, mill scale, etc) or other iron compounds. (A description of the Höganäs Sponge Iron process can be found in ASM Handbook volume 7, Powder Metallurgy.) A typical sponge iron has a metallic iron content of 90-99%, with the balance being mainly unreduced iron oxide, carbon and oxide impurities such as SiO₂, Al₂O₃, CaO, MnO, V₂O₅, etc. The specific surface of sponge iron is typically in the range of 75 to 600 m²/kg, measured according to the B.E.T. method. Sponge iron with higher specific surface can however be produced. Sponge iron can be produced in any desirable particle size and particle shape. As previously mentioned the present invention is not limited to particles of pure sponge iron but any metallic iron of suitable particle size and shape can be used. Preferably these particles should have a large surface available for the gas to reach, with other words they should have a certain porosity or permeability.

The sorbent can be employed in any suitable part of a process. It can for example be employed in the form of a fixed filter bed, a moving bed, a fluidised bed or a transport reactor. It could also potentially be applied already in the gasification reactor. When a fixed bed is employed a particle size of 0.5-10 mm is preferred, a smaller particle size would generate a too large pressure drop. When e.g. a fluidised bed is used, the particles need to be light enough to be fluidised, and the pressure drop is a less significant issue. Preferably a particle size of less than 1 mm should be used.

The results obtained so far indicate that the concentration of hydrogen sulphide of the desulphurized gas can be reduced to less than 200 ppmv and even less than 30 ppmv and that the extent of desulphurisation depends on process conditions, such as the composition of the syngas and the temperature. Our experiments also disclose that desulphurization will be obtained when the syngas has a temperature between 300° and 800° C., preferably between 400° and 700° C. and most preferably between 400° and 600° C.

The used filter medium, consisting essentially of iron sulphide (FeS), can be used for producing sulphuric acid or elemental sulphur either once, or as a step in a regeneration procedure as previously described. It could also be used for production of iron salts, as an additive to steel melts, etc.

As the used filter medium can be considered harmless, it can also be disposed of. Waste deposition has the ecological advantage of removing sulphur from the biosphere. Sulphuric acid is today available in excess on the world market due to the larges volumes being generated as by-product from energy production and metal production. It is therefore an attractive option to put sulphur back into the ground where it came from.

The invention is further illustrated by the following non limiting examples.

### EXAMPLE 1

85 g of sponge iron particles were placed on a quartz filter inside a quartz tube of 37 mm internal diameter. The sponge iron particles were mainly of 2-5 mm diameter. The bed height was about 5 cm. The bed was heated under argon atmosphere to desired temperature and a gas stream of the following composition was passed through the filter from below: 98.3%(vol) Ar, 1.3%(vol) H₂S)

The H₂S content in the exit gas was measured by bubbling the exit gas through an acid solution containing starch as an indicator, and using iodine solution as a titration agent. At the beginning of the experiment, a certain volume of iodine solution is added to the acid starch solution resulting in a blue colour. As H₂S is dissolved and consumes iodine, the blue colour disappears. Then a new portion of iodine solution is rapidly added and so on.

The experiment was repeated at several different temperatures.

After breakthrough of hydrogen sulphide was reached, the gas flow was discontinued. The filter bed was allowed to cool to room temperature in streaming argon before it was taken out and weighed. As the sponge iron contained about 97% metallic iron, complete conversion of Fe to FeS corresponds to a weight increase of 55.7%.

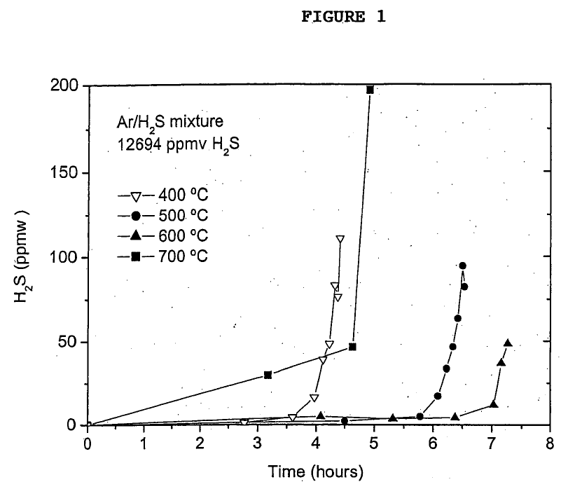

As can be seen from FIG. 1 a very high degree of sorption was reached, with the best results at 500° C. and 600° C. During these experiments, only a few ppm H₂S was detected in the exit gas. The breakthrough was very sharp, and a high degree of conversion of iron to iron sulphide had been achieved at breakthrough.

### EXAMPLE 2

145 g of sponge iron particles were placed in a quartz tube, as in Example 1. This time the tube had an inner diameter of 55 mm. The experiment was performed at 500° C. and 400° C. A gas stream of the following composition was passed through the filter from below: 4.9% N₂, 45.7% H₂, 48.8% CO, 5673 ppmv(0.57%) H₂S. One further experiment at 400° C. was made with 15.5 e H₂ and 37.3% N₂, 46.6% CO, 0.56% H₂S. The linear flow rate of the gas stream was 2.5 cm/s. The H₂S content in the exit gas was measured as in example 1. The H₂S concentration in the exit gas increased and stabilised after about 45 minutes. The experiments were discontinued after about 2 hours.

The results of the titration can be seen in the table.

| | Highest measured | Calculated equilibrium concentration |
|---|---|---|
| Experimental | concentration H₂S | H₂S based on hydrogen concentration |
| conditions | in exit gas. | in feed gas*. |
| 500° C., | 88 ppmv | 48 ppmv |
| 45.7% H₂ | | |
| 500° C., | 20 ppmv | 15 ppmv |
| 15.5% H₂ | | |
| 400° C., | 29 ppmv | 10 ppmv |
| 45.7% H₂ | | |

*The equilibrium factors were calculated with the help of the database “HSC Chemisty 5, Copyright: Outkumpu Research Oy, Pori, Finland

It was shown that the concentration of hydrogen had a great influence on the absorption of hydrogen sulphide due to the equilibrium reaction: Fe+H₂S⇄FeS+H₂ The equilibrium is temperature dependent, with lower temperatures being advantageous for the sulphidation of iron.

The experimental results are well in accordance with calculated equilibrium values. There seems to be a slower speed of reaction at 400° C. than at 500° C., making it more difficult to reach close to equilibrium.

### Example 3

145 g of sponge iron particles were placed in a quartz tube, as in Example 1. The tube had an inner diameter of 55 mm. The experiment was performed at 500° C. and 600° C. A gas stream of the following composition was passed through the filter from below: 60.8% N₂, 11.0% H₂, 16.6% CO, 7.2% H₂O, 3.8% CO₂, 0.58% H₂S.

The linear flow rate of the gas stream was 2.5 cm/s. The H₂S content in the exit gas was measured as in example 1.

At 600° C., the H₂S concentration in the exit gas stabilised above 100 ppmv at first, but began to rise after 2 hours. After 5 hours the experiment was discontinued as the concentration had reached almost 800 ppm. The expected weight increase after this time was 5% based on mass balance with regard to sulphur between feed gas and titrated amount. The measured weight increase was however 29%, and it was obvious also from visual appearance that most of the filter material had been oxidized. Instead of getting a golden colour of FeS, most of the filter material turned to a darker grey colour.

At 500° C., the concentration of H₂S stabilised just below 100 ppm. The experiment was discontinued after 2 hours. The expected weight increase based on a mass balance was 1.6%, but the measured weight increase was 7.5%. Again the visual appearance of the filter material indicated that oxidation had taken place.

This example demonstrates that high amounts of oxidising components have a negative influence of the desulphurization process.

1. A method for desulfurization of syngas comprising the steps of contacting a sulphur containing syngas having a temperature between 300° C. and 800° C. gas with a sorbent containing metallic iron in order to form a sulphur containing iron compound and a gas substantially free from sulphur and sulphur compounds.

2. Method as claimed in claim 1, wherein the syngas is produced by gasification or pyrolysis of plastic or rubber waste, of bio-fuel, such as wood chips or agricultural waste, or from coal or by reformation of petroleum, natural gas and other gases.

3. Method according to claim 1, wherein the sulphur to be removed by desulphurization is mainly present in the form of hydrogen sulphide (H₂S) and/or carbonyl sulphide (COS).

4. Method according to claim 1, wherein the syngas is essentially non oxidizing for iron.

5. Method according to claim 1, wherein the temperature of the syngas subjected to the desulphurization is between 400° C. and 700° C.

6. Method according to claim 1 wherein the sorbent consists of more than 50% by weight metallic iron.

7. Method according to the claim 6 wherein the iron is in the form of particles having a size varying between 0.01 and 10 mm.

8. Method according to claim 6 wherein the iron is in the form of a sponge iron particles.

9. Method according to claim 6, wherein the iron particles have a specific surface area as measured according to the B.E.T. method of at least 25 m²/kg.

10. Method according to claim 2, wherein the sulphur to be removed by desulphurization is mainly present in the form of hydrogen sulphide (H2S) and/or carbonyl sulphide (COS).

11. Method according to claim 2, wherein the syngas is essentially non oxidizing for iron.

12. Method according to claim 3, wherein the syngas is essentially non oxidizing for iron.

13. Method according to claim 10, wherein the syngas is essentially non oxidizing for iron.

14. Method according to claim 1, wherein the temperature of the syngas subjected to the desulphurization is between 400° C. and 600° C.

15. Method according to claim 1, wherein the sorbent consists of more than 90% by weight metallic iron.

16. Method according to claim 6, wherein the iron is in the form of particles having a size varying between 0.1 and 5 mm.

17. Method according to claim 2, wherein the iron is in the form of particles having a size varying between 0.1 and 5 mm.

18. Method according to claim 7, wherein the iron is in the form of a sponge iron particles.

19. Method according to claim 7, wherein the iron particles have a specific surface area as measured according to the B.E.T. method of at least 25 m²/kg.

20. Method according to claim 8, wherein the iron particles have a specific surface area as measured according to the B.E.T. method of at least 25 m²/kg.
